(19) United States
(12) Patent Application Publication
(10) Pub. No.: US 2026/0268650 A1
(43) Pub. Date: Sep. 10, 2026

(54) DETECTION DEVICE, DETECTION METHOD, AND NON-TRANSITORY COMPUTER-READABLE MEDIUM

(71) Applicant: NEC Corporation, Tokyo (JP)

(72) Inventors: Yaeko YONEZAWA, Tokyo (JP); Syunsuke YAMAMOTO, Tokyo (JP); Yuji TAHARA, Tokyo (JP)

(73) Assignee: NEC Corporation, Tokyo (JP)

(21) Appl. No.: 19/166,565

(22) PCT Filed: Mar. 28, 2023
(86) PCT No.: PCT/JP2023/012482

§ 371 Date: Sep. 18, 2025

(51) Int. Cl. G06V 10/70; G06T 7/70; G06V 10/25; G06V 10/26; G06V 10/774

(52) U.S. Cl. CPC G06V 10/87; G06T 7/70; G06V 10/25; G06V 10/26; G06T 2207/20081; G06V 10/774

(57) ABSTRACT

Please delete the Abstract of the Disclosure, and replace it with the following:

A detection device, wherein a determination unit determines, on the basis of an orientation in which an article is placed on a shelf stage corresponding to each shelf stage image region, a use model used in a case where the shelf stage image regions are defined as image regions being processed, from among a plurality of models. Each of the plurality of models is used for detecting an article group image region. The plurality of models have different detection characteristics from each other. The detection unit applies the use model to the image regions being processed, thereby detecting the article group image region in the image regions being processed.

### TECHNICAL FIELD

The present disclosure relates to a detection device, a detection method, and a non-transitory computer-readable medium.

### BACKGROUND ART

There has been proposed a technology for detecting a region in which an article group continuously exists in an image of the article group such as commodities using one trained identification model (for example, PTL 1).

### CITATION LIST

### Patent Literature

PTL 1: JP 2021-117531 A

### SUMMARY OF INVENTION

### Technical Problem

The present inventor has found that there is a possibility that the detection accuracy of an image region cannot be sufficiently obtained using one identification model. That is, the identification model usually has detection targets with high detection performance and detection targets with low detection performance. Therefore, the present inventor has found that the detection accuracy of the image region can be improved by applying a first model and a second model having different characteristics to the image of the article group.

An object of the present disclosure is to provide a detection device, a detection method, and a non-transitory computer-readable medium capable of improving the detection accuracy of the image region. The object is merely one of a plurality of objects to be achieved by a plurality of example embodiments disclosed herein. The other objects or problems and novel features will be apparent from the description of the present specification or the accompanying drawings.

### Solution to Problem

In one aspect, a detection device includes:
a first detection unit that detects a single-article image of a single article in a captured image in which an article shelf is imaged;
a first specification unit that specifies a plurality of shelf-image regions relevant to a plurality of shelf stages of the article shelf in the captured image;
a determining unit that determines a posture in which an article is placed on a shelf stage relevant to each shelf-image region based on a single-article image detected in each shelf-image region;
a determination unit that determines a use model used in a case where each shelf-image region is set as an image region to be processed from among a plurality of models in which each model is a model for detecting an article group image region and detection characteristics are different from each other based on a posture in which the article is placed; and
a second detection unit that detects an article group image region relevant to an image of an article group in the image region to be processed by applying the use model to the image region to be processed.

In another aspect, a detection method includes:
detecting a single-article image of a single article in a captured image in which an article shelf is imaged;
specifying a plurality of shelf-image regions relevant to a plurality of shelf stages of the article shelf in the captured image;
determining a posture in which an article is placed on a shelf stage relevant to each shelf-image region based on a single-article image detected in each shelf-image region;
determining a use model used in a case where each shelf-image region is set as an image region to be processed from among a plurality of models in which each model is a model for detecting an article group image region and detection characteristics are different from each other based on a posture in which the article is placed; and
detecting an article group image region relevant to an image of an article group in the image region to be processed by applying the use model to the image region to be processed.

In other aspects, a non-transitory computer-readable medium stores a program for causing a detection device to execute processing including:
detecting a single-article image of a single article in a captured image in which an article shelf is imaged;
specifying a plurality of shelf-image regions relevant to a plurality of shelf stages of the article shelf in the captured;
determining a posture in which an article is placed on a shelf stage relevant to each shelf-image region based on a single-article image detected in each shelf-image region;
determining a use model used in a case where each shelf-image region is set as an image region to be processed from among a plurality of models in which each model is a model for detecting an article group image region and detection characteristics are different from each other based on a posture in which the article is placed; and
detecting an article group image region relevant to an image of an article group in the image region to be processed by applying the use model to the image region to be processed.

### Advantageous Effects of Invention

According to the aspects of the present disclosure, it is possible to provide a detection device, a detection method, and a non-transitory computer-readable medium capable of improving the detection accuracy of the image region.

### BRIEF DESCRIPTION OF DRAWINGS

FIG. 1 is a block diagram illustrating an example of a detection device according to a first example embodiment.

FIG. 2 is a flowchart illustrating an example of a processing operation of a detection device according to the first example embodiment.

FIG. 3 is a block diagram illustrating an example of a detection device according to a second example embodiment.

FIG. 4A is a diagram illustrating an example of an article shelf image.

FIG. 4B is a diagram illustrating an example of a second image region.

FIG. 4C is a diagram illustrating an example of a first image region.

FIG. 5 is a block diagram illustrating an example of a detection device according to a third example embodiment.

FIG. 6 is a diagram illustrating an example of an integrated image.

FIG. 7 is a diagram illustrating a hardware configuration example of a detection device.

### EXAMPLE EMBODIMENT

Hereinafter, example embodiments will be described with reference to the drawings. In the example embodiments, the same or equivalent elements are denoted by the same reference numerals, and repeated description will be omitted.

### FIRST EXAMPLE EMBODIMENT

### Configuration Example of Detection Device

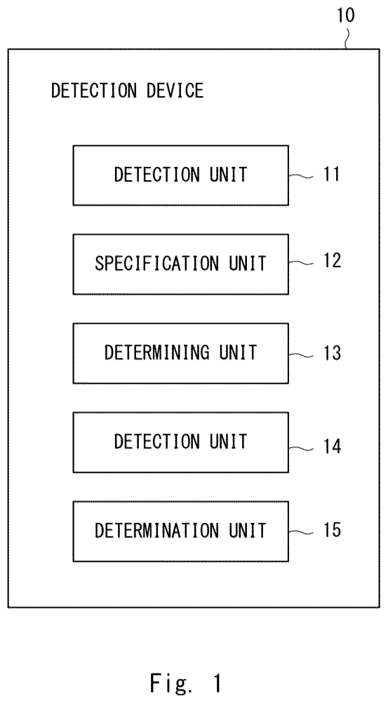

FIG. 1 is a block diagram illustrating an example of a detection device according to the first example embodiment. In FIG. 1, a detection device 10 includes a detection unit (first detection unit) 11, a specification unit (first specification unit) 12, a determining unit 13, a detection unit (second detection unit) 14, and a determination unit 15. This captured image is, for example, an article shelf image obtained by imaging an article shelf. The following description will be made assuming that the captured image is the article shelf image. The article shelf has a plurality of shelf stages.

The detection unit 11 detects an “single-article image” of a single article in the captured image. For example, the detection unit 11 may detect the “single-article image” using “artificial intelligence (AI) that detects an individual”.

The specification unit 12 specifies a plurality of “shelf-image regions” relevant to a plurality of shelf stages in the captured image. A shelf-image region relevant to one shelf stage is, for example, an image region relevant to a space between the shelf panel of one shelf stage and the shelf panel of a shelf stage immediately above the one shelf stage.

The determining unit 13 determines the posture in which the article is placed on the shelf stage relevant to each shelf-image region based on the single-article image detected in each shelf-image region. Examples of the posture in which the article is placed on the shelf stage include a standing posture (hereinafter, it may be referred to as a “first posture”) and a lying posture (hereinafter, it may be referred to as a “second posture”).

Based on the “posture in which the article is placed on the shelf stage” determined by the determining unit 13, the determination unit 15 determines the “use model” used in a case where each shelf-image region is set as the “image region to be processed” of the detection unit 14 from the plurality of models. Each of the plurality of models is used for detecting an article group image region. The plurality of models have different detection characteristics from each other.

The detection unit 14 applies the “use model” to the “image region to be processed” to detect the “article group image region” relevant to the image of the article group in the image region to be processed. The detection unit 14 sets each of the plurality of shelf-image regions specified by the specification unit 12 as a “image region to be processed”.

### Operation Example of Detection Device

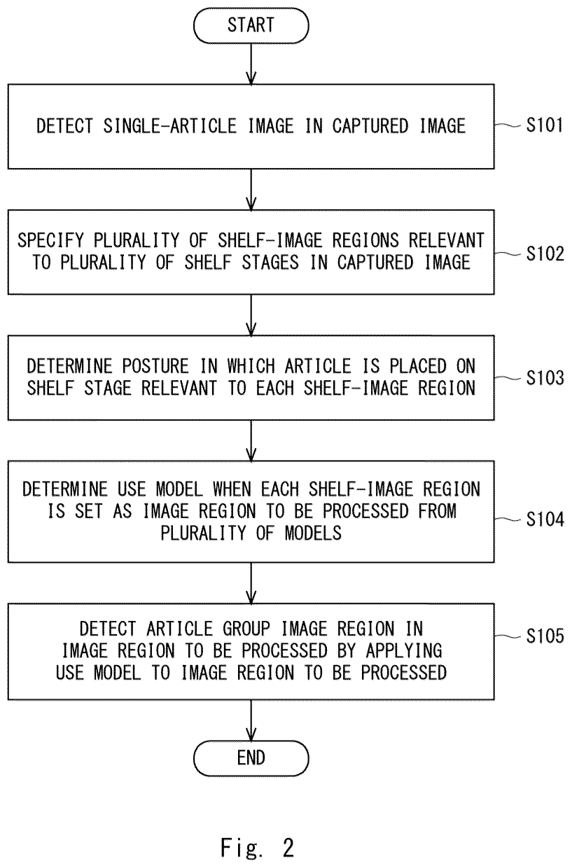

An example of a processing operation of the detection device 10 having the above-described configuration will be described. FIG. 2 is a flowchart illustrating an example of the processing operation of the detection device according to the first example embodiment.

The detection unit 11 detects the single-article image in the captured image (step S101).

The specification unit 12 specifies a plurality of shelf-image regions relevant to a plurality of shelf stages in the captured image (step S102).

The determining unit 13 determines the posture in which the article is placed on the shelf stage relevant to each shelf-image region based on the single-article image detected in each shelf-image region (step S103).

Based on the “posture in which the article is placed on the shelf stage” determined, the determination unit 15 determines the use model used in a case where each shelf-image region is set as the image region to be processed from the plurality of models (step S104).

The detection unit 14 applies the use model to the image regions being processed, thereby detecting the article group image region in the image regions being processed (step S105).

As described above, according to the first example embodiment, the detection device 10 detects an article group image region in the captured image by using the plurality of models having different detection characteristics from each other. Thus, since one model can compensate for the low detection performance of the other model in detecting the detection target, the detection accuracy of the article group image region can be improved.

The detection device 10, wherein the determination unit 15 determines, based on an orientation in which an article is placed on a shelf stage relevant to each shelf-image region, a use model used in a case where the shelf-image regions are defined as image regions being processed, from among a plurality of models. Each of the plurality of models is used for detecting an article group image region. The plurality of models have different detection characteristics from each other. The detection unit 14 applies the use model to the image regions being processed, thereby detecting the article group image region in the image regions being processed.

With the configuration of the detection device 10, a model according to the arrangement mode of the article in each shelf stage can be applied to the shelf-image region, so that the detection accuracy of the article group image region can be improved.

### Second Example Embodiment

A second example embodiment relates to an example embodiment that describes the first example embodiment in more detail.

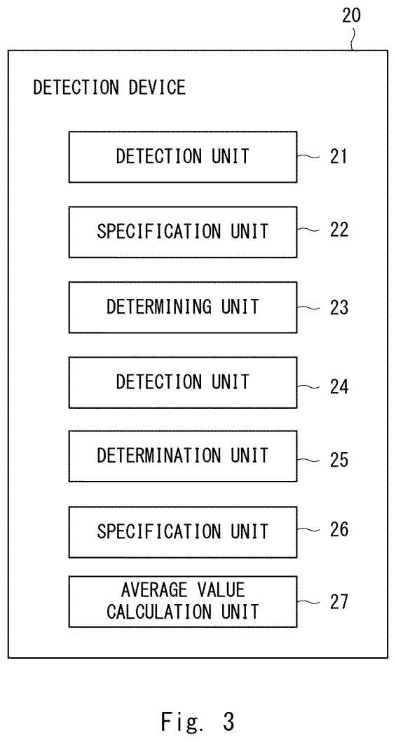

FIG. 3 is a block diagram illustrating an example of a detection device according to the second example embodiment. In FIG. 3, the detection device 20 includes a detection unit (first detection unit) 21, a specification unit (first specification unit) 22, a determining unit 23, a detection unit (second detection unit) 24, a determination unit 25, a specification unit (second specification unit) 26, and an average value calculation unit 27. The detection device 20 acquires a captured image similarly to the detection device 10 of the first example embodiment. This captured image is, for example, an article shelf image obtained by imaging an article shelf. The following description will be made assuming that the captured image is the article shelf image. The article shelf has a plurality of shelf stages.

Similarly to the detection unit 11 of the first example embodiment, the detection unit (first detection unit) 21 detects an “single-article image” of a single article in the captured image.

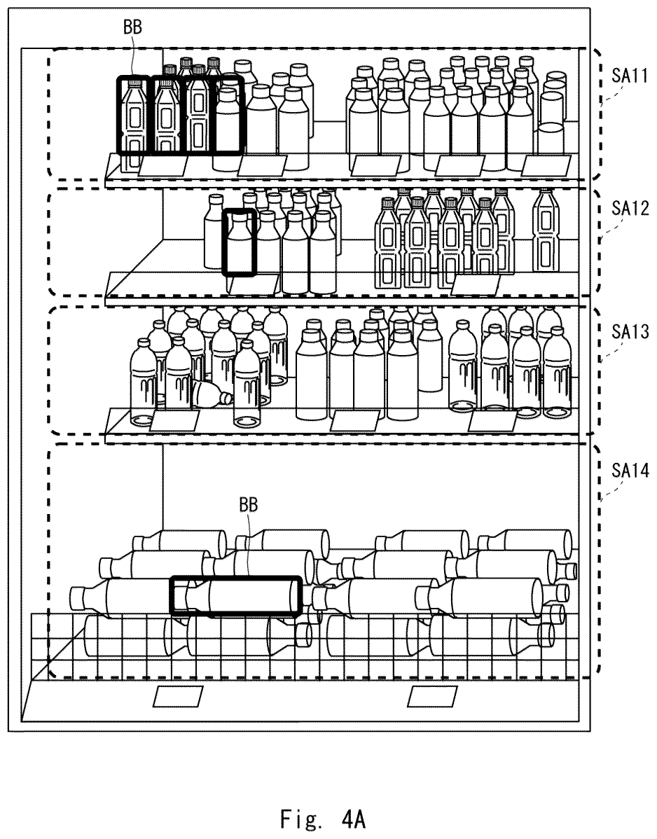

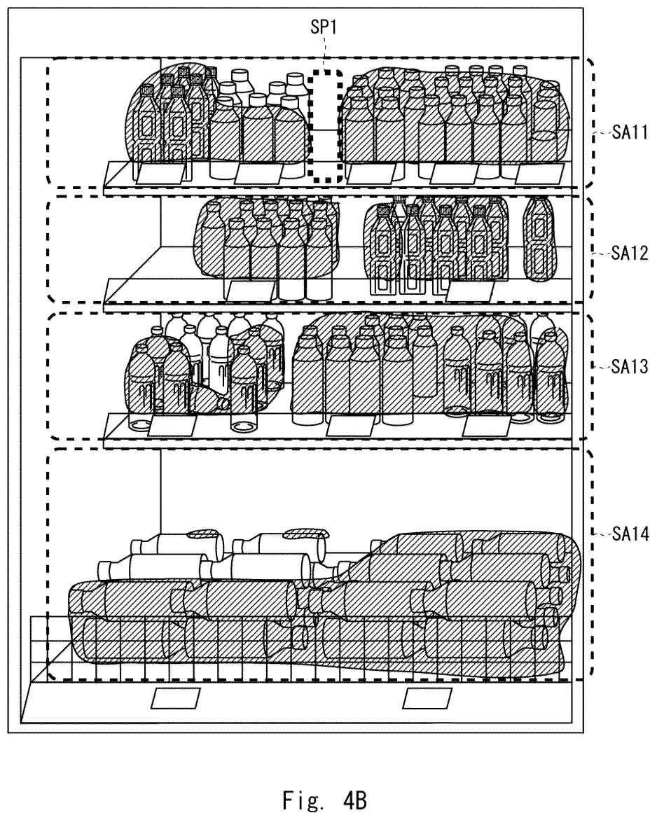

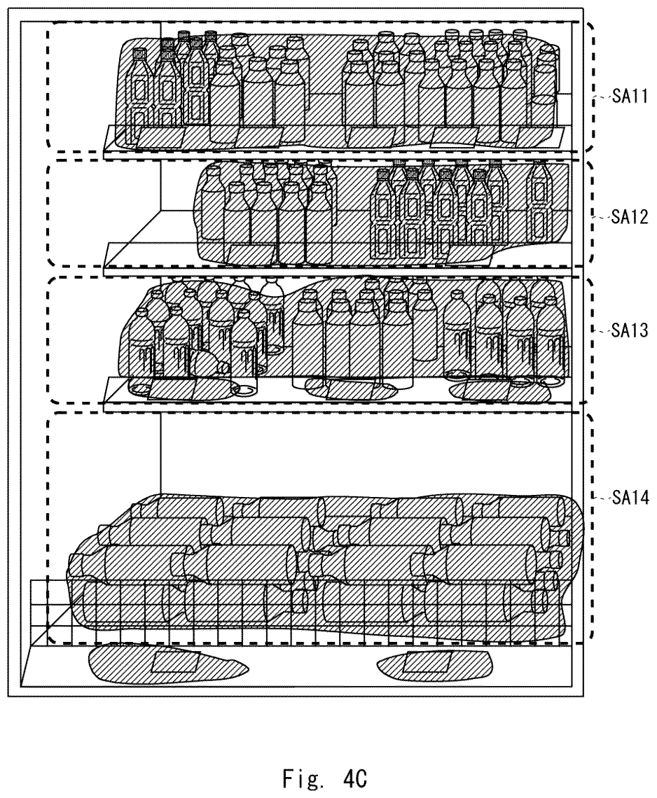

FIG. 4A is a diagram illustrating an example of the article shelf image. FIG. 4A illustrates an article shelf image of a shelf on which plastic-bottled beverages are displayed. The article shelf shown in the article shelf image in FIG. 4A has four shelf stages. On three shelf stages from the top, plastic bottles as articles are arranged in a standing position. On the bottom shelf stage, plastic bottles are arranged in a horizontal position and in a stacked manner. On three shelf stages from the top, spaces above the plastic bottles are narrow, and on the bottom shelf stage, a space above the plastic bottles is wide. Therefore, most of the plastic bottles at the back are hidden by the plastic bottles on the front side in the image showing the three shelf stages from the top, and the plastic bottles backward are also shown in the image showing the bottom shelf stage.

For example, each image region surrounded by a rectangular frame BB in FIG. 4A is relevant to the “single-article image”. The rectangular frame may be a so-called bounding box.

Returning to the description of FIG. 3, similarly to the specification unit 12 of the first example embodiment, the specification unit 22 (first specification unit) specifies a plurality of “shelf-image regions” relevant to a plurality of shelf stages in the captured image. For example, the specification unit 22 may specify a line relevant to a surface of the article in contact with the shelf panel of the article shelf in the single-article image. Then, the specification unit 22 may specify the plurality of shelf-image regions by dividing the captured image by the specified line. That is, the specification unit 22 may specify the image region sandwiched between two adjacent lines as the “shelf-image region”.

Alternatively, for example, the specification unit 22 may directly specify the front image of the shelf panel by pattern matching or the like. The front image of the shelf panel can also be specified as a line relevant to the surface of the plastic bottle in contact with the shelf panel. The specification unit 22 may specify the image region sandwiched between two adjacent lines as the “shelf-image region”. The image regions SA11, SA12, SA13, and SA14 surrounded by frames in FIG. 4A are examples of the shelf-image regions.

The average value calculation unit 27 calculates an average value of lengths relevant to the height direction of the article shelf of at least single-article image in each shelf-image region. That is, in the example of FIG. 4A, the average value for the three shelf stages from the top tends to be large because plastic bottles are arranged in a standing posture on these shelf stages. On the other hand, the average value for the lowest shelf stage tends to be small because plastic bottles are arranged in a state of lying sideways.

The specification unit (second specification unit) 26 specifies the length of each shelf-image region relevant to the height direction of the article shelf as the height (a) of each shelf-image region.

Similarly to the determining unit 13 of the first example embodiment, the determining unit 23 determines the posture in which the article is placed on the shelf stage relevant to each shelf-image region based on the single-article image detected in each shelf-image region.

For example, the determining unit 23 calculates the “reference value” for each shelf-image region by multiplying the height (a) of each shelf-image region by a predetermined ratio (for example, 0.7). Then, the determining unit 23 determines the posture in which the article is placed on the shelf stage relevant to each shelf-image region by comparing the calculated “reference value” for each shelf-image region with the average value for the length of the single-article image relevant to each shelf-image region calculated by the average value calculation unit 27. For example, in a case where the average value for the target shelf-image region is greater than or equal to the reference value for the target shelf-image region, the determining unit 23 may determine that the posture in which the article is placed is a standing posture (that is, the first posture) on the shelf stage relevant to the target shelf-image region. On the other hand, used in a case where the average value relevant to the target shelf-image region is less than the reference value for the target shelf-image region, the determining unit 23 may determine that the posture in which the article is placed is the posture of being laid sideways (that is, the second posture) on the shelf stage relevant to the target shelf-image region.

Similarly to the determination unit 15 of the first example embodiment, based on the “posture in which the article is placed on the shelf stage” determined by the determining unit 23, the determination unit 25 determines the “use model” used in a case where each shelf-image region is set as the “image region to be processed” of the detection unit 24 from the plurality of models.

For example, the determination unit 25 determines the “second model” as the “use model” for the shelf-image region relevant to the shelf stage for which the posture in which the article is placed is determined to be a standing posture. On the other hand, the determination unit 25 determines the “first model” as the “use model” for the shelf-image region relevant to the shelf stage for which it is determined that the posture in which the article is placed is the posture of being laid sideways.

### Here, the First Model and the Second Model Will Be Described.

The “second model” is a model that identifies an image region (hereinafter, referred to as a “second image region” or a “second article group image region”) relevant to an image of an article group disposed on the front side in a target image. Hereinafter, the “image of the article group” may be referred to as an “article group image”.

For example, the second model may be a trained model trained using training data including the following images.
An image obtained by imaging the entire one side of a single article.
An article shelf image obtained by designating, as an “article group image region”, an image region relevant to the article group image of an article group arranged in the foremost row of each shelf stage in the article shelf image.

In each article of the article group arranged in the foremost row of the shelf stage, most (for example, a portion occupying more than half of one side) of one side of the article usually appears in the article shelf image.

The training is performed using such training data, and thus the second model can accurately detect the image region relevant to an article group located on the front side of each shelf stage. However, there is a possibility that the second model cannot accurately detect the image region relevant to the article group that is located behind the article group located on the front side and in which most of one sides of the commodities are hidden.

The above-described “first model” is a model that identifies an image region (hereinafter, referred to as a “first image region” or a “first article group image region”) based on a space primarily occupied by the article group in the target image (hereinafter, referred to as an “space primarily occupied by the articles”).

For example, the first model may be a trained model trained using training data including the following images.
An image obtained by imaging the entire one side of a single article.
An article shelf image obtained by designating, as an “article group image region”, an image region relevant to the article group image of an article group arranged in the foremost row of each shelf stage in the article shelf image.
An article shelf image obtained by designating, as a “true background image region”, an image region relevant to an “image relevant to a true background (hereinafter, referred to as a “true background image”)” in the article shelf image.

Here, the “true background image region” includes an image of a back panel, a side panel, or a shelf panel of the article shelf which is shown in the article shelf image without being hidden by the shadow of the articles in the article shelf image.

The training is performed using such training data, and thus the first model has characteristics capable of accurately detecting an image region highly likely to be a background image (for example, an image region relevant to a large empty space in which articles are not arranged) and an image region relevant to the above-described space primarily occupied by the articles. However, since the first model is trained using Conflicting information such as the “article group image region” and the “true background image region”, there is a possibility that a region close to the “article group image region” is detected as the “article group image region” and a region close to the “true background image region” is detected as the “true background image region” for a region that is not designated as both the “article group image region” and the “true background image region”. Therefore, there is a possibility that an image region relevant to a narrow empty space sandwiched between two “article group image regions” is detected as a part of the article group image region. This is because it is considered that there are many cases where sufficient information for detecting that an image is a background image cannot be obtained from an image relevant to the narrow empty space.

Unlike the training data of the first model, the training data of the second model does not include the article shelf image for which the “true background image region” is designated, or has a small number of the article shelf images for which the “true background image region” is designated even in a case of including the article shelf image.

Similarly to the detection unit 14 of the first example embodiment, the detection unit (second detection unit) 24 applies the “use model” to the “image region to be processed” to detect the “article group image region” relevant to the image of the article group in the image region to be processed.

For example, the detection unit 24 detects the “second image region” by applying the second model to the shelf-image region relevant to the shelf stage in which the posture in which the article is placed is determined to be the standing posture. The detection unit 24 detects the “first image region” by applying the first model to the shelf-image region relevant to the stage in which the posture in which the article is placed is determined to be the posture of being laid sideways.

FIG. 4B is a diagram illustrating an example of the second image region. FIG. 4B illustrates a result of applying the second model to the article shelf image of FIG. 4A. In FIG. 4B, a hatched region is relevant to the second image region. In practice, the second model is not applied to the shelf-image region SA14 in which the posture in which the article is placed is the posture of being laid sideways, but for reference, a result of applying the second model to the shelf-image region SA14 is also illustrated in FIG. 4B.

As can be seen from FIG. 4B, the second model can accurately detect the article group image region relevant to a plastic bottle group in the image showing the three shelf stages from the top. As a result, the second model can accurately detect even an image region relevant to a narrow empty space sandwiched between two article group image regions.

On the other hand, as can be seen from FIG. 4B, in the image showing the bottom shelf stage, although the article group image region relevant to the plastic bottle group located on the front side can be detected, the article group image region relevant to the plastic bottle group located backward cannot be detected.

FIG. 4C is a diagram illustrating an example of the first image region. In FIG. 4C, a hatched region in a shelf-image region SA14 is relevant to the first image region. In practice, the first model is not applied to the shelf-image regions SA11, SA12, and SA13, which are postures in which the article is placed in the standing posture, but for reference, a result of applying the second model to the shelf-image regions SA11, SA12, and SA13 is also illustrated in FIG. 4C.

As can be seen from FIG. 4C, in the shelf-image region SA14 (that is, the image showing the bottom shelf stage), the model 1 can accurately detect not only the article group image region relevant to the plastic bottle group located on the front side but also the article group image region relevant to the plastic bottle group located backward. As can be seen from FIGS. 4B and 4C, there is a possibility that the model 1 detects, as a part of the article group image region, an image region SP1 relevant to a narrow empty space sandwiched between two article group image regions.

As described above, according to the second example embodiment, the determination unit 25 in the detection device 20 determines the “second model” as the “use model” for the shelf-image region relevant to the shelf stage for which the posture in which the article is placed is determined to be the standing posture. The determination unit 25 determines the “first model” as the “use model” for the shelf-image region relevant to the shelf stage for which it is determined that the posture in which the article is placed is the posture of being laid sideways. The second model is a model for discerning the second image region relevant to an image of an article group arranged at the front side in a target image. The first model is a model for discerning the first image region based on the space primarily occupied by the articles in the target image.

With the configuration of the detection device 20, the detection accuracy of the article group image region can be improved. That is, for example, there is a high possibility that even the article located backward is imaged in the shelf-image region relevant to the shelf stage in which the posture in which the article is placed is determined to be the posture of being laid sideways. In a case where the second model is applied to such a shelf-image region, there is a possibility that an image region relevant to the articles located backward cannot be accurately detected. On the other hand, in a case where the first model is applied to such a shelf-image region, there is a high possibility that an image region relevant to the articles located backward can be accurately detected. On the other hand, there is a high possibility that the shelf-image region in which the posture in which the article is placed is determined to be a standing posture hardly shows the article located backward. In a case where the second model is applied to such a shelf-image region, there is a high possibility that an image region relevant to the commodity group located on the front side can be accurately detected. Therefore, since one model can compensate for the low detection performance of the other model in detecting the detection target, the detection accuracy of the article group image region can be improved.

### Modified Example of Second Example Embodiment

In the above description, in a case where the average value for the target shelf-image region is greater than or equal to the reference value for the target shelf-image region, the determining unit 23 determines that the posture in which the article is placed is the standing posture (that is, the first posture) on the shelf stage relevant to the target shelf-image region. Then, the description has been given assuming that, in a case where the average value relevant to the target shelf-image region is less than the reference value for the target shelf-image region, the determining unit 23 determines that the posture in which the article is placed is the posture of being laid sideways (that is, the second posture) on the shelf stage relevant to the target shelf-image region. However, the present disclosure is not limited thereto.

For example, the determining unit 23 may determine the posture in which the article is placed on the shelf stage relevant to each shelf-image region based on the ratio of the longitudinal and lateral lengths of the single-article image detected in each shelf-image region. For example, in a case where the height direction of the article shelf is defined as vertical and the direction orthogonal to the height direction is defined as horizontal, the vertical length of the single-article image relevant to the plastic bottle in the standing posture is longer than the horizontal length, and thus the value of the vertical length/horizontal length is larger than 1. On the other hand, since the vertical length of the single-article image relevant to the plastic bottles in the posture laid sideways is shorter than the horizontal length, the value of the vertical length/horizontal length is smaller than 1. Therefore, it is possible to determine the posture in which the article is placed on the shelf stage relevant to each shelf-image region based on the ratio of the longitudinal and lateral lengths of the single-article image detected in each shelf-image region.

### Third Example Embodiment

A third example embodiment relates to specification of an empty space.

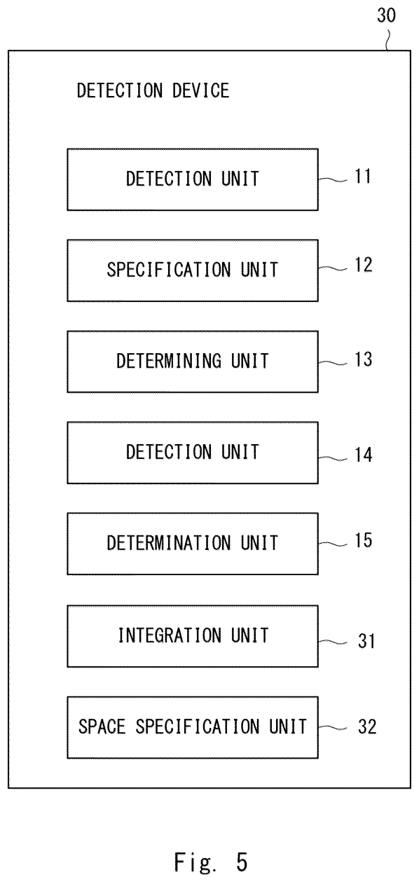

FIG. 5 is a block diagram illustrating an example of a detection device according to the third example embodiment. In FIG. 5, a detection device 30 includes a detection unit (first detection unit) 11, a specification unit (first specification unit) 12, a determining unit 13, a detection unit (second detection unit) 14, a determination unit 15, an integration unit 31, and a space specification unit 32.

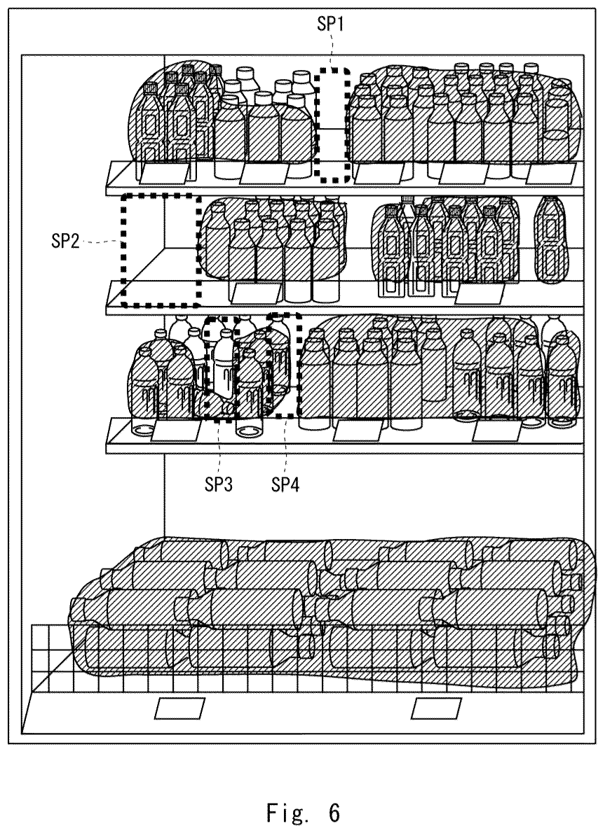

The integration unit 31 integrates the first image region in the image region to be processed detected by the detection unit 14 and the second image region in the image region to be processed detected by the detection unit 11 to obtain an “integrated image”. For example, in the cases of FIGS. 4B and 4C, the second image regions in the shelf-image regions SA11, SA12, and SA13 detected by the second model and the first image region in the shelf-image region SA14 detected by the first model are integrated to form the “integrated image”. FIG. 6 is a diagram illustrating an example of the integrated image.

The space specification unit 32 specifies an empty space in which the articles are not arranged on each shelf stage based on the integrated image. For example, the space specification unit 32 may specify the empty space by subtracting the integrated image from the shelf-image region. In FIG. 6, for example, portions surrounded by rectangular frames (space SP1, SP2, SP3, and SP4) relevant to empty spaces.

As described above, since the detection device 30 according to the third example embodiment specifies the empty space based on the integrated image obtained by integrating the image regions obtained by applying the first model and the second model to the shelf-image region that is a detection target with high detection performance, it is possible to accurately specify the empty space.

Although the description has been made assuming that the integration unit 31 and the space specification unit 32 are applied to the detection device 10 of the first example embodiment, the present disclosure is not limited thereto. The integration unit 31 and the space specification unit 32 may be applied to the detection device 20 of the second example embodiment.

### Other Example Embodiments

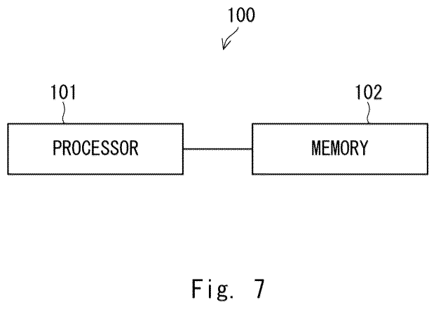

FIG. 7 is a diagram illustrating a hardware configuration example of a detection device. In FIG. 7, a detection device 100 includes a processor 101 and a memory 102. The processor 101 may be, for example, a microprocessor, a micro processing unit (MPU), or a central processing unit (CPU). The processor 101 may include a plurality of processors. The memory 102 is configured by a combination of a volatile memory and a nonvolatile memory. The memory 102 may include a storage located apart from the processor 101. In this case, the processor 101 may access the memory 102 via an I/O interface (not illustrated).

Each of the detection devices 10, 20, and 30 according to the first to third example embodiments can have the hardware configuration illustrated in FIG. 7.

The detection units 11 and 21, the specification units 12 and 22, the determining units 13 and 23, the detection units 14 and 24, the determination units 15 and 25, the specification unit 26, the average value calculation unit 27, the integration unit 31, and the space specification unit 32 of the detection devices 10, 20, and 30 according to the first to third example embodiments may be implemented by the processor 101 reading and executing a program stored in the memory 102. The program can be stored using various types of non-transitory computer-readable media and supplied to the detection devices 10, 20, and 30. Examples of the non-transitory computer-readable media include magnetic recording media (for example, flexible disks, magnetic tapes, or hard disk drives), and magneto-optical recording media (for example, magneto-optical disks). Other examples of the non-transitory computer-readable media include a read only memory (CD-ROM), a CD-R, and a CD-R/W. Other examples of the non-transitory computer-readable media include a semiconductor memory. Examples of the semiconductor memory include a mask ROM, a programmable ROM (PROM), an erasable PROM (EPROM), a flash ROM, and a random access memory (RAM). The program may be supplied to the detection devices 10, 20, and 30 by various types of transitory computer-readable media. Examples of transitory computer-readable media include electrical signals, optical signals, and electromagnetic waves. The transitory computer-readable media can supply the program to the detection devices 10, 20, and 30 via a wired communication path such as an electric wire or an optical fiber, or a wireless communication path.

Although the invention of the present application has been described above with reference to the example embodiments, the invention of the present application is not limited to the above. Various modifications that can be understood by those skilled in the art can be made to the configuration and details of the invention of the present application within the scope of the invention.

Some or all of the above-described example embodiments may be described as the following supplementary notes, but are not limited to the following supplementary notes.

### Supplementary Note 1

A detection device including:
a first detection unit that detects a single-article image of a single article in a captured image in which an article shelf is imaged;
a first specification unit that specifies a plurality of shelf-image regions relevant to a plurality of shelf stages of the article shelf in the captured image;
a determining unit that determines a posture in which an article is placed on a shelf stage relevant to each shelf-image region based on a single-article image detected in each shelf-image region;
a determination unit that determines a use model used in a case where each shelf-image region is set as an image region to be processed from among a plurality of models in which each model is a model for detecting an article group image region and detection characteristics are different from each other based on a posture in which the article is placed; and
a second detection unit that detects an article group image region relevant to an image of an article group in the image region to be processed by applying the use model to the image region to be processed.

### Supplementary Note 2

The detection device according to Supplementary Note 1, in which
the plurality of models include a first model that identifies a first article group image region based on a space primarily occupied by an article group in a target image, and a second model that identifies a second article group image region relevant to an image of an article group arranged on a front side in a target image, and
the determination unit is configured to: determine the second model as the use model for a shelf-image region relevant to a shelf stage for which it is determined that a posture in which the article is placed is a standing posture; and determine the first model as the use model for a shelf-image region relevant to a shelf stage for which it is determined that a posture in which the article is placed is a posture of being laid sideways.

### Supplementary Note 3

The detection device according to Supplementary Note 1, further including:
a second specification unit that specifies a length of each shelf-image region relevant to a height direction of the article shelf as a height of each shelf-image region; and
an average value calculation unit that calculates an average value of lengths relevant to the height direction of at least one single-article image detected by the first detection unit in each shelf-image region,
wherein the determining unit is configured to: determine, in a case where the average value for a target shelf-image region is greater than or equal to a value obtained by multiplying a height of the target shelf-image region by a predetermined ratio, that a posture in which an article is placed is a standing posture on the shelf stage relevant to the target shelf-image region; and determine, in a case where the average value relevant to the target shelf-image region is less than a value obtained by multiplying a height of the shelf stage relevant to the target shelf-image region by the predetermined ratio, that the shelf stage relevant to the target shelf-image region is a posture in which an article is laid sideways.

### Supplementary Note 4

The detection device according to Supplementary Note 1, in which the determining unit determines a posture in which the article is placed on a shelf stage relevant to each shelf-image region based on a ratio of longitudinal and lateral lengths of a single-article image detected in each shelf-image region.

### Supplementary Note 5

The detection device according to Supplementary Note 1, in which the first specification unit specifies a line relevant to a surface of an article in contact with a shelf panel of the article shelf in the single-article image, and specifies the plurality of shelf-image regions by dividing the captured image with the plurality of lines.

### Supplementary Note 6

The detection device according to Supplementary Note 2, further including an integration unit that obtains an integrated image by integrating the first article group image region obtained by applying the first model to the image region to be processed and the second article group image region obtained by applying the second model to the image region to be processed.

### Supplementary Note 7

The detection device according to Supplementary Note 6, further including a space specification unit that specifies an empty space in which articles are not arranged on each shelf stage based on the integrated image.

### Supplementary Note 8

A detection method including:
detecting a single-article image of a single article in a captured image in which an article shelf is imaged;
specifying a plurality of shelf-image regions relevant to a plurality of shelf stages of the article shelf in the captured image;
determining a posture in which an article is placed on a shelf stage relevant to each shelf-image region based on a single-article image detected in each shelf-image region;
determining a use model used in a case where each shelf-image region is set as an image region to be processed from among a plurality of models in which each model is a model for detecting an article group image region and detection characteristics are different from each other based on a posture in which the article is placed; and
detecting an article group image region relevant to an image of an article group in the image region to be processed by applying the use model to the image region to be processed.

### Supplementary Note 9

The detection method according to Supplementary Note 8, in which
the plurality of models include a first model that identifies a first article group image region based on a space primarily occupied by an article group in a target image, and a second model that identifies a second article group image region relevant to an image of an article group arranged on a front side in a target image, and
the determining includes: determining the second model as the use model for a shelf-image region relevant to a shelf stage for which it is determined that a posture in which the article is placed is a standing posture; and determining the first model as the use model for a shelf-image region relevant to a shelf stage for which it is determined that a posture in which the article is placed is a posture of being laid sideways.

### Supplementary Note 10

A non-transitory computer-readable medium storing a program for causing
a detection device to execute processing including: detecting a single-article image of a single article in a captured image in which an article shelf is imaged;
specifying a plurality of shelf-image regions relevant to a plurality of shelf stages of the article shelf in the captured image;
determining a posture in which an article is placed on a shelf stage relevant to each shelf-image region based on a single-article image detected in each shelf-image region;
determining a use model used in a case where each shelf-image region is set as an image region to be processed from among a plurality of models in which each model is a model for detecting an article group image region and detection characteristics are different from each other based on a posture in which the article is placed; and
detecting an article group image region relevant to an image of an article group in the image region to be processed by applying the use model to the image region to be processed.

### Supplementary Note 11

The non-transitory computer-readable medium of Supplementary Note 10, in which
the plurality of models include a first model that identifies a first article group image region based on a space primarily occupied by an article group in a target image, and a second model that identifies a second article group image region relevant to an image of an article group arranged on a front side in a target image, and
the determining includes: determining the second model as the use model for a shelf-image region relevant to a shelf stage for which it is determined that a posture in which the article is placed is a standing posture; and determining the first model as the use model for a shelf-image region relevant to a shelf stage for which it is determined that a posture in which the article is placed is a posture of being laid sideways.

### REFERENCE SIGNS LIST

10 detection device
11 detection unit (first detection unit)
12 specification unit (first specification unit)
13 determining unit
14 detection unit (second detection unit)
15 determination unit
20 detection device
22 specification unit (first specification unit)
23 determining unit
24 detection unit (second detection unit)
25 determination unit
26 specification unit (second specification unit)
27 average value calculation unit
30 detection device
31 integration unit
32 space specification unit

What is claimed is:

1. A detection device comprising:
at least one memory storing instructions, and
at least one processor configured to execute the instructions to perform processing, the processing comprising:
detecting a single-article image of a single article in a captured image in which an article shelf is imaged;
specifying a plurality of shelf-image regions relevant to a plurality of shelf stages of the article shelf in the captured image;
determining a posture in which an article is placed on a shelf stage relevant to each shelf-image region based on a single-article image detected in each shelf-image region;
determining a use model used in a case where each shelf-image region is set as an image region to be processed from among a plurality of models in which each model is a model for detecting an article group image region and detection characteristics are different from each other based on a posture in which the article is placed; and
detecting an article group image region relevant to an image of an article group in the image region to be processed by applying the use model to the image region to be processed.

2. The detection device according to claim 1, wherein
the plurality of models include a first model that identifies a first article group image region based on a space primarily occupied by an article group in a target image, and a second model that identifies a second article group image region relevant to an image of an article group arranged on a front side in a target image, and
the determining of the use model includes: determining the second model as the use model for a shelf-image region relevant to a shelf stage for which it is determined that a posture in which the article is placed is a standing posture; and determining the first model as the use model for a shelf-image region relevant to a shelf stage for which it is determined that a posture in which the article is placed is a posture of being laid sideways.

3. The detection device according to claim 1, wherein the processing further comprises:
specifying a length of each shelf-image region relevant to a height direction of the article shelf as a height of each shelf-image region; and
calculating an average value of lengths relevant to the height direction of at least one single-article image detected by the first detection unit in each shelf-image region,
wherein the determining of the posture includes: determining, in a case where the average value for a target shelf-image region is greater than or equal to a value obtained by multiplying a height of the target shelf-image region by a predetermined ratio, that a posture in which an article is placed is a standing posture on the shelf stage relevant to the target shelf-image region; and determining, in a case where the average value relevant to the target shelf-image region is less than a value obtained by multiplying a height of the shelf stage relevant to the target shelf-image region by the predetermined ratio, that a posture in which an article is placed is a posture of being laid sideways on the shelf stage relevant to the target shelf-image region.

4. The detection device according to claim 1, wherein the determining of the posture includes determining a posture in which the article is placed on a shelf stage relevant to each shelf-image region based on a ratio of longitudinal and lateral lengths of a single-article image detected in each shelf-image region.

5. The detection device according to claim 1, wherein the specifying of the plurality of shelf-image regions includes specifying a line relevant to a surface of an article in contact with a shelf panel of the article shelf in the single-article image, and specifying the plurality of shelf-image regions by dividing the captured image with the specified line.

6. The detection device according to claim 2, wherein the processing further comprises obtaining an integrated image by integrating the first article group image region obtained by applying the first model to the image region to be processed and the second article group image region obtained by applying the second model to the image region to be processed.

7. The detection device according to claim 6, further wherein the processing further comprises specifying an empty space in which articles are not arranged on each shelf stage based on the integrated image.

8. A detection method comprising:
detecting a single-article image of a single article in a captured image in which an article shelf is imaged;
specifying a plurality of shelf-image regions relevant to a plurality of shelf stages of the article shelf in the captured image;
determining a posture in which an article is placed on a shelf stage relevant to each shelf-image region based on a single-article image detected in each shelf-image region;
determining a use model used in a case where each shelf-image region is set as an image region to be processed from among a plurality of models in which each model is a model for detecting an article group image region and detection characteristics are different from each other based on a posture in which the article is placed; and
detecting an article group image region relevant to an image of an article group in the image region to be processed by applying the use model to the image region to be processed.

9. The detection method according to claim 8, wherein
the plurality of models include a first model that identifies a first article group image region based on a space primarily occupied by an article group in a target image, and a second model that identifies a second article group image region relevant to an image of an article group arranged on a front side in a target image, and
the determining includes: determining the second model as the use model for a shelf-image region relevant to a shelf stage for which it is determined that a posture in which the article is placed is a standing posture; and determining the first model as the use model for a shelf-image region relevant to a shelf stage for which it is determined that a posture in which the article is placed is a posture of being laid sideways.

10. A non-transitory computer-readable medium storing a program for causing a detection device to execute processing including:
detecting a single-article image of a single article in a captured image in which an article shelf is imaged;
specifying a plurality of shelf-image regions relevant to a plurality of shelf stages of the article shelf in the captured image;
determining a posture in which an article is placed on a shelf stage relevant to each shelf-image region based on a single-article image detected in each shelf-image region;
determining a use model used in a case where each shelf-image region is set as an image region to be processed from among a plurality of models in which each model is a model for detecting an article group image region and detection characteristics are different from each other based on a posture in which the article is placed; and
detecting an article group image region relevant to an image of an article group in the image region to be processed by applying the use model to the image region to be processed.

11. The non-transitory computer-readable medium according to claim 10, wherein
the plurality of models include a first model that identifies a first article group image region based on a space primarily occupied by an article group in a target image, and a second model that identifies a second article group image region relevant to an image of an article group arranged on a front side in a target image, and
the determining includes: determining the second model as the use model for a shelf-image region relevant to a shelf stage for which it is determined that a posture in which the article is placed is a standing posture; and determining the first model as the use model for a shelf-image region relevant to a shelf stage for which it is determined that a posture in which the article is placed is a posture of being laid sideways.
